(19) United States
(12) Patent Application Publication
(10) Pub. No.: US 2004/0125244 A1
(43) Pub. Date: Jul. 1, 2004

(54) Deformable mirror system and method of controlling form of reflecting surface

(75) Inventor: Takayuki Ide, Hachioji-shi (JP)

Correspondence Address: SCULLY SCOTT MURPHY & PRESSER, PC, 400 GARDEN CITY PLAZA, GARDEN CITY, NY, 11530

(73) Assignee: OLYMPUS CORPORATION, TOKYO (JP)

(21) Appl. No.: 10/735,168

(22) Filed: Dec. 12, 2003

(30) Foreign Application Priority Data
Dec. 17, 2002 (JP) 2002-365417

(51) Int. Cl. H04N 5/74

(52) U.S. Cl. 348/755

(57) ABSTRACT

A deformable mirror system comprises: a deformable mirror which includes a flexible thin film and a control electrode, the flexible thin film having a reflecting surface deformable by an electrostatic attractive force and an upper electrode, and the control electrode being arranged opposite to the upper electrode; and a power supply configured to apply a potential difference between the upper electrode and the control electrode of the deformable mirror, and to control the form of the reflecting surface of the deformable mirror to a desired form. The power supply controls the amount of deforming the reflecting surface by changing a duty ratio of a voltage applied across the upper electrode and the control electrode.

### CROSS-REFERENCE TO RELATED APPLICATIONS

This application is based upon and claims the benefit of priority from the prior Japanese Patent Application No. 2002-365417, filed Dec. 17, 2002, the entire contents of which are incorporated herein by reference.

### BACKGROUND OF THE INVENTION

1. Field of the Invention

The present invention relates to a deformable mirror system driven by an electrostatic force, and a method of controlling a reflecting surface of a deformable mirror to control the amount of deformation of the reflecting surface.

2. Description of the Related Art

A system driven by an electrostatic force can be made compact with high accuracy at a low cost by the so-called Micro Electro-Mechanical System (MEMS) using semiconductor manufacturing technology.

In a micro-optical system such as an optical pickup applied to micro-optics, a micro-deformable mirror changeable in the curvature of its reflecting surface has been proposed for the purpose of simplifying the mechanism related to focusing using a conventional electromagnetic actuator. Further, application of a deformable mirror to small photographing optics can make a great contribution to reducing the size.

Generally, when changing the form by an electrostatic attractive force in such a deformable mirror, an upper electrode having a reflecting surface and a control electrode are located opposite to each other, as disclosed in Jpn. Pat. Appln. KOKAI Publication No. 2-101402. The form of the reflecting surface is changed by an electrostatic attractive force by applying a voltage across these electrodes.

### BRIEF SUMMARY OF THE INVENTION

A deformable mirror system according to one aspect of the present invention, comprises: a deformable mirror which includes a flexible thin film and a control electrode, the flexible thin film having a reflecting surface deformable by an electrostatic attractive force and an upper electrode, and the control electrode being arranged opposite to the upper electrode; and a power supply configured to apply a potential difference between the upper electrode and the control electrode of the deformable mirror, and to control the form of the reflecting surface of the deformable mirror to a desired form. The power supply controls the amount of deforming the reflecting surface by changing a duty ratio of a voltage applied across the upper electrode and the control electrode.

A method of controlling a form of a reflecting surface according to one aspect of the present invention, comprises: applying a potential difference between an upper electrode and a control electrode of a deformable mirror to control the form of the reflecting surface of the deformable mirror to a desired form, the deformable mirror including a flexible thin film and the control electrode, the flexible thin film having the reflecting surface deformable by an electrostatic attractive force and the upper electrode, and the control electrode being arranged opposite to the upper electrode. Changing a duty ratio of a voltage applied across the upper electrode and the control electrode controls the amount of deforming the reflecting surface.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing the structure of a deformable mirror in a deformable mirror system according to a first embodiment of the present invention;

FIG. 2 is a schematic diagram showing the relationship between a deformable mirror and a voltage applying unit;

FIG. 3 is a graph showing an example of the waveform of the voltage applied to a deformable mirror;

FIG. 4 is a graph showing the measurement results of the center displacement characteristic of a deformable mirror when PWM control and constant-voltage control are performed;

FIG. 5A is a graph showing an example of the waveform of the voltage applied to a deformable mirror in a deformable mirror system according to a second embodiment of the present invention;

FIG. 5B is a graph showing an example of the waveform of the current to flow in the deformable mirror in the deformable mirror system according to the second embodiment;

FIG. 6 is a schematic diagram of a deformable mirror system according to a third embodiment of the present invention;

FIG. 7A is a graph showing an example of the waveform of the voltage applied to a deformable mirror;

FIG. 7B is a graph showing an example of the waveform of the current to flow in a deformable mirror;

FIG. 8 is a schematic diagram of a deformable mirror system according to a fourth embodiment of the present invention; and

FIG. 9 is a graph showing an example of the waveform of the voltage applied to a deformable mirror.

### DETAILED DESCRIPTION OF THE INVENTION

Hereinafter, embodiments of the present invention will be explained with reference to the attached drawings.

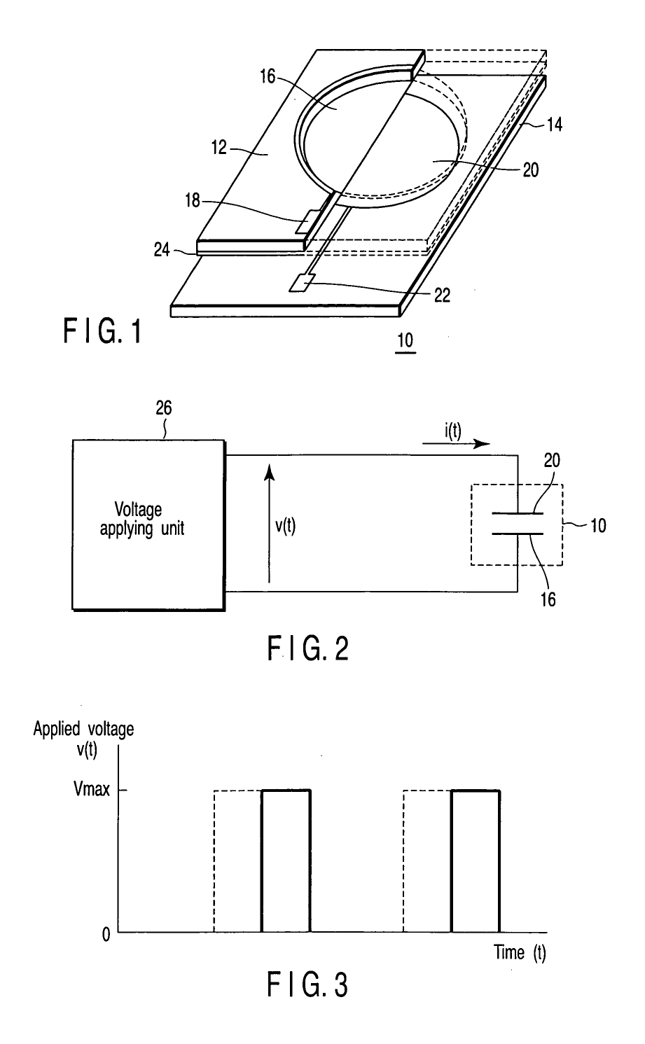

First, a first embodiment of the present invention will be explained by referring to FIG. 1 to FIG. 4.

As shown in FIG. 1, a deformable mirror 10 in a deformable mirror system according to a first embodiment includes an upper substrate 12 and a lower substrate 14. The upper substrate 12 includes an upper electrode 16 having a function of a reflecting surface, and an external lead electrode 18. The lower substrate 14 includes a control electrode 20 and an external lead electrode 22. The upper substrate 12 and the lower substrate 14 are arranged with an appropriate gap therebetween so that the upper electrode 16 and control electrode 20 are located opposite to each other. When a voltage is applied across the upper electrode 16 and control electrode 20 through the external lead electrodes 18 and 22, an electrostatic attractive force acts between these electrodes, the reflecting surface supported by a flexible thin film 24 bends to the control electrode 20, and the curvature changes.

The deformable mirror system according to the first embodiment comprises the deformable mirror 10 which act as above described, and a voltage applying unit 26 as a control means, as shown in FIG. 2. The voltage applying unit 26 generates a voltage to be applied to the deformable mirror 10. The output voltage from the voltage applying unit 26 is assumed to be v(t), and the current to flow into the deformable mirror 10 is assumed to be i(t).

FIG. 3 is a graph showing an example of the waveform of the voltage applied to the deformable mirror 10. In this embodiment, as shown in the drawing, the maximum value of the voltage is considered constant, and the applying time is controlled (Pulse Wide Modulation (hereinafter abbreviated to PWM) control). In this drawing, the solid line indicates the waveform of the applied voltage with a duty ratio of 25%, the broken line indicates the waveform of the applied voltage with a duty ratio of 50%, and Vmax indicates the maximum value of the applied voltage. In PWM control like this, the duty ratio defines the amount of deforming of the reflecting surface, and Vmax defines the maximum amount of deforming of the reflecting surface. Further, it is possible to determine uniquely the amount of deforming of the reflecting surface by the duty ratio, by setting Vmax to a constant value.

The case of the above-mentioned PWM control is compared with the case of constant-voltage control. Considering the deformable mirror 10 a parallel flat capacitor, the electrostatic attractive force generated between the upper electrode 16 and the control electrode 20 is expressed by the following equation (1).

f=(½)ε(V/d)² (1)

Where, f is the electrostatic attractive force, ε is the dielectric constant between the electrodes, V is the voltage across the electrodes, and d is the gap between the electrodes. By changing the duty ratio by PWM, the effective electrostatic attractive force can be expressed by the following equation (2).

f=(½)ε(Vmax/d)²D (2)

Where, f is the electrostatic attractive force, ε is the dielectric constant between the electrodes, Vmax is the maximum voltage across the electrodes, d is a gap between the electrodes, and D is the duty ratio. According to the above equation (1), in the case of constant-voltage control, the electrostatic attractive force is proportional to the square of the applied voltage, or the control parameter. Conversely, according to the above equation (2), in the case of PWM control, the electrostatic attractive force is proportional to the duty ratio, or the control parameter.

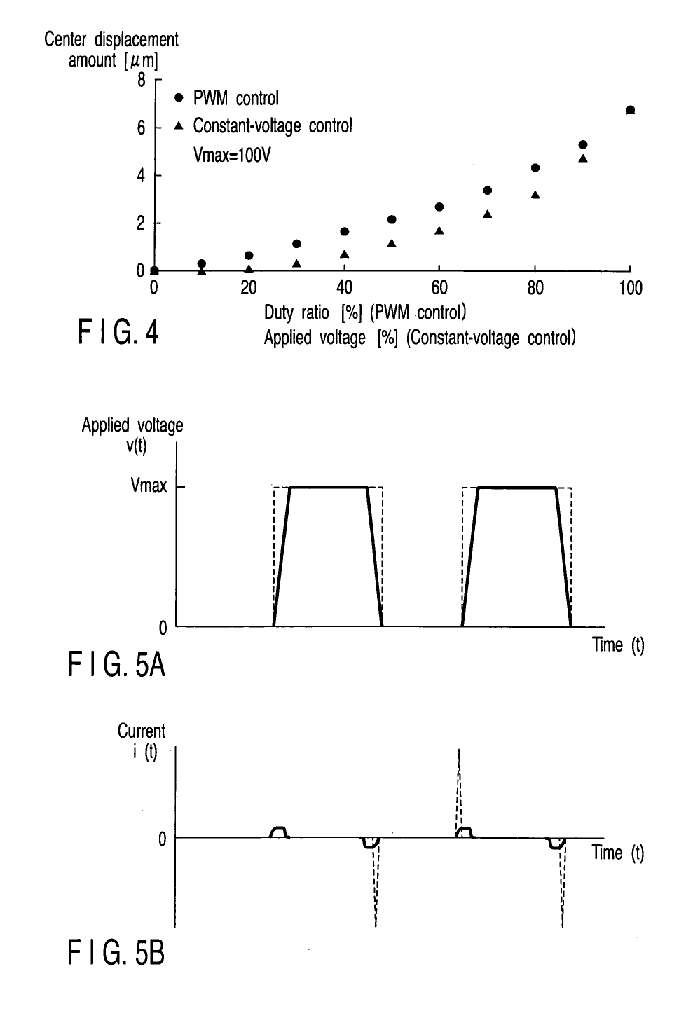

FIG. 4 shows the measurement results of the center displacement characteristic of the deformable mirror 10 when PWM control and constant-voltage control are performed. In the deformable mirror 10 used for the measurement, the upper electrode 16 as the reflecting surface is made circular with a diameter of 8 mm, and the gap between the upper electrode 16 and control electrode 20 is 25 μm. The waveform condition for PWM control is 20 kHz for the frequency and 100 V for the Vmax. The horizontal axis of FIG. 4 represents the duty ratio in the case of PWM control, and the voltage in the case of constant-voltage control. The vertical axis represents the displacement at the center of the reflecting surface. As shown in the drawing, in PWM control, the linearity of the center displacement for an input parameter is higher and the deformation control of the reflecting surface becomes easier, compared with constant-voltage control. It is to be noted that the displacement from the linearity of the center displacement relating to the duty ratio in PWM control, and the displacement from the square of the center displacement relating to the applied voltage in constant-voltage control, are caused by that as the reflecting film is deformed, the gap between the upper electrode 16 and control electrode 20 becomes small, and the equivalent electrostatic capacitance of the deformable mirror 10 increases.

Moreover, if the PWM control frequency is set to the resonance frequency of the flexible thin film 24 having the reflecting surface and the upper electrode 16, the reflecting surface is largely oscillated by resonance, and the reflecting surface form cannot be controlled. Thus, it is necessary to set the frequency to higher than the resonance frequency of the flexible thin film 24 having the reflecting surface and the upper electrode 16. Further, when an audible range frequency is applied, oscillation noise is generated by the micro-oscillation of the deformable mirror 10. When this oscillation noise cause a problem, it is necessary to set the frequency for PWM control to higher than the audible frequency. Since the human audible frequency range is generally up to about 20 kHz, the oscillation noise can be cancelled by setting the PWM control frequency to higher than 20 kHz.

As above explained, according to the first embodiment, the relation between the duty ratio and center displacement amount becomes more linear in PWM control, compared with the relation between the applied voltage and center displacement amount the constant-voltage control, and the control becomes easy. Further, the resonance of the flexible thin film 24 can be prevented by setting the drive frequency of PWM control to increase than the resonance frequency of the flexible thin film 24 having the reflecting surface and the upper electrode 16. Or, the resonance of the flexible thin film 24 and the oscillation noise caused by micro-oscillation can be prevented by setting the PWM control frequency to higher than the higher one of the flexible thin film 24 resonance frequency and the audible frequency. Or, the resonance of the flexible thin film 24 and the oscillation noise caused by micro-oscillation can be prevented by setting the PWM control frequency to higher than the higher one of the flexible thin film 24 resonance frequency and 20 kHz.

Next, a second embodiment of the present invention will be explained by referring to FIG. 5A and FIG. 5B.

The deformable mirror 10 can be considered equivalent to the capacitance in the electric characteristic. Thus, when the voltage state is changed by PWM control, electric current flows in the deformable mirror 10. For example, when a rectangular wave with rapid voltage change, as shown by the broken line in FIG. 5A, is applied to the deformable mirror 10, the current to flow in the deformable mirror 10 becomes a pulse wave with a large maximum value, as shown by the broken line in FIG. 5B. Such current applies a large load to a power supply. Particularly, this becomes a very serious problem when the deformable mirror 10 is applied to electric equipment whose power supply capacity is limited, such as portable equipment.

As a method of decreasing a peak current, in the second embodiment, a high-frequency component is reduced in the voltage waveform generated from the voltage applying unit 26. As a method of reducing a high-frequency component, a trapezoidal waveform is applied to the deformable mirror 10, as shown by the solid line in FIG. 5A. That is, assuming the current to flow in the deformable mirror 10 to be i, the gradient of a trapezoidal waveform to be a and the equivalent electrostatic capacitance of the deformable mirror 10 to be C, i=αC is established. The peak current can be decreased by making the gradient smaller. Namely, as shown by the solid line in FIG. 5B, it is possible to make the waveform with a very small peak value, though the integrated amount is the same compared with the broken line.

As above explained, according to the second embodiment, the voltage applying unit 26 generates a trapezoidal waveform and applies it to the deformable mirror 10, and the maximum value of the current to flow when the voltage state is changed by PWM control is made small, and the load on the power supply can be reduced.

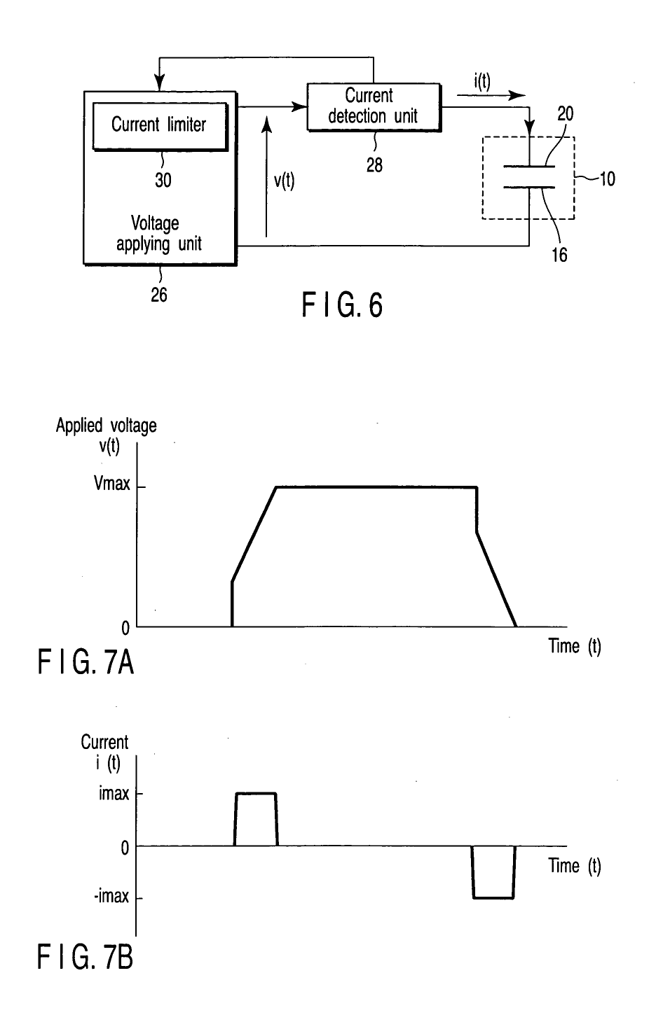

Next, a third embodiment of the present invention will be explained by using FIG. 6 to FIG. 7B.

In the third embodiment, as a method of decreasing the peak current as described above, the current to flow in the deformable mirror 10 is detected, so that a current greater than a standard value is not allowed to flow. That is, as shown in FIG. 6, the deformable mirror system according to this embodiment has a current detection unit 28, which detects the current to flow in the deformable mirror 10. Further, the voltage applying unit 26 has a current limiter 30, which controls the current value not to exceed the standard value, in accordance with the output of the current detection unit 28.

With this structure, as shown in FIG. 7A and FIG. 7B, when the current flowing in the deformable mirror 10 is lower than the standard value (imax), the gradient of the output voltage of the voltage applying unit 26 is kept high. And, when the current reaches the standard value, the current is limited not to increase further, and the gradient of the output voltage of the voltage applying unit 26 becomes small.

By feeding back as above described, regardless of the load fluctuation in the deformable mirror 10, the voltage transition time can be reduced to the shortest time. Namely, in PWM control, the voltage transition time causes an error in the duty ratio, and causes a reason to determine the minimum width of the voltage applying time. Thus, it is necessary to reduce the voltage transition time to be as short as possible. Therefore, as shown in this embodiment, it is very effective for increasing the control accuracy of the deformable mirror 10 to reduce the voltage transition time to the shortest, regardless of the load fluctuation in the deformable mirror 10.

As above explained, according to the third embodiment, the current flowing in the deformable mirror 10 is detected by the current detection unit 28, the flow of current is limited not to exceed the standard value, and the voltage transition time can be reduced to the shortest time within the standard current regardless of the load fluctuation in the deformable mirror 10.

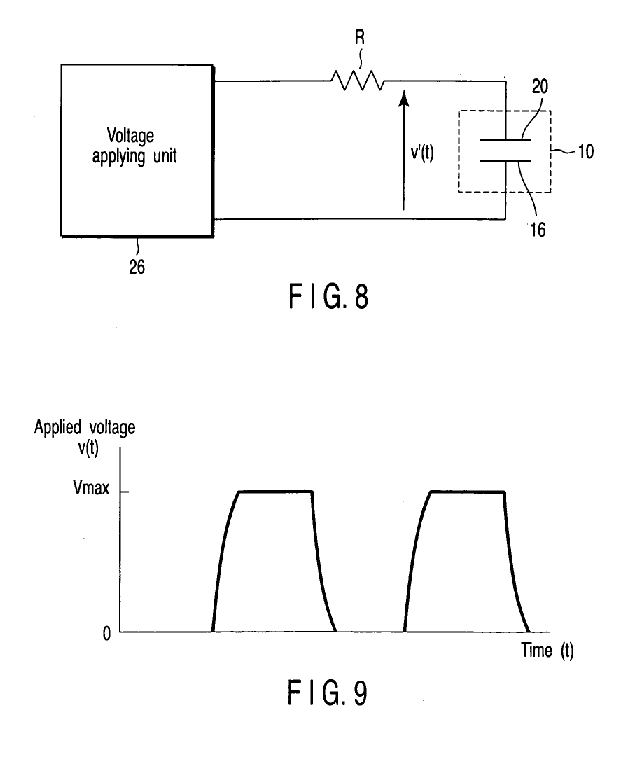

Next, a fourth embodiment of the present invention will be explained by using FIG. 8 and FIG. 9.

In the fourth embodiment, as a method of decreasing the peak current as described above, a resistor or inductance or both are inserted between the voltage applying unit 26 and the control electrode 20. A resistor and inductance have impedance against a high frequency. Thus, by inserting these elements between the voltage applying unit 26 and the control electrode 20, the high-frequency component of the voltage applied to the deformable mirror 10 can be reduced.

Namely, as shown in FIG. 8, by inserting a resistor R between the voltage applying unit 26 and the control electrode 20, even if the output waveform from the voltage applying unit 26 is a rectangular waveform, the waveform of the voltage v′(t) applied to the deformable mirror 10 becomes less sharp upon transition, as shown in FIG. 9. Thus, it becomes possible to decrease the peak current. It is to be noted that the value of the resistor R is determined considering the rise and fall time, the equivalent electrostatic capacitance of the deformable mirror 10, the maximum voltage of PWM control and the maximum peak current.

The impedance against high frequency is also increased by inserting an inductance instead of the resistor R. However, in this case, resonance may occur caused by the impedance component and the equivalent electrostatic capacitance of the deformable mirror 10. Therefore, it is necessary to add a resistor component or consider the value of the inductance.

Further, the electric elements such as a resistor and inductance can be formed monolithically on a substrate (the upper substrate 12) for forming the deformable mirror 10 with ease by the semiconductor manufacturing technology, by using a silicon substrate as the substrate. The necessary components can be included in the deformable mirror 10 in this way, and it becomes unnecessary to add externally the above electric elements. This is effective for making the system compact.

As above explained, according to the fourth embodiment, a resistor or inductance or both are inserted between the power supply and the control electrode 20, the waveform of the voltage applied to the deformable mirror 10 becomes less sharp upon transition, even if the output waveform from the voltage applying unit 26 is a rectangular wave, and the peak current can be reduced. Further, a silicon substrate is used to form the deformable mirror 10, the resistance or inductance or both are formed monolithically on the silicon substrate, and the system can be made compact.

Additional advantages and modifications will readily occur to those skilled in the art. Therefore, the invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. A deformable mirror system comprising:
a deformable mirror which includes a flexible thin film and a control electrode, the flexible thin film having a reflecting surface deformable by an electrostatic attractive force and an upper electrode, and the control electrode being arranged opposite to the upper electrode; and
a power supply configured to apply a potential difference between the upper electrode and the control electrode of the deformable mirror, and to control the form of the reflecting surface of the deformable mirror to a desired form; wherein
the power supply controls the amount of deforming the reflecting surface by changing a duty ratio of a voltage applied across the upper electrode and the control electrode.

2. The system according to claim 1, wherein a frequency of the voltage applied across the upper electrode and the control electrode is higher than a resonance frequency of the flexible thin film having the reflecting surface and the upper electrode.

3. The system according to claim 1, wherein a frequency of the voltage applied across the upper electrode and the control electrode is higher than a higher one of a resonance frequency of the flexible thin film having the reflecting surface and the upper electrode, and a maximum audible frequency.

4. The system according to claim 3, wherein the maximum audible frequency is 20 kHz.

5. The system according to claim 1, wherein an waveform of the voltage applied across the upper electrode and the control electrode is suppressed in a high-frequency component compared with a rectangular wave.

6. The system according to claim 5, wherein at least one of a resistor and an element having an inductance component is inserted into one of an electric circuit between the power supply and the upper electrode and an electric circuit between the power supply and the control electrode.

7. The system according to claim 6, wherein
a member which supports one of the flexible thin film and control electrode is configured by a silicon substrate; and
at least one of the resistor and the element having the inductance component is arranged on the silicon substrate.

8. The system according to claim 1, wherein the power supply limits the current to flow in one of the upper electrode and the control electrode of the deformable mirror, to be lower than a predetermined value.

9. A method of controlling a form of a reflecting surface, comprising:
applying a potential difference between an upper electrode and a control electrode of a deformable mirror to control the form of the reflecting surface of the deformable mirror to a desired form, the deformable mirror including a flexible thin film and the control electrode, the flexible thin film having the reflecting surface deformable by an electrostatic attractive force and the upper electrode, and the control electrode being arranged opposite to the upper electrode, wherein
the amount of deforming the reflecting surface is controlled by changing a duty ratio of a voltage applied across the upper electrode and the control electrode.

10. A deformable mirror system comprising:
a deformable mirror which includes a flexible thin film and a control electrode, the flexible thin film having a reflecting surface deformable by an electrostatic attractive force and an upper electrode, and the control electrode being arranged opposite to the upper electrode; and
control means for applying a potential difference between the upper electrode and the control electrode of the deformable mirror, and to control the form of the reflecting surface of the deformable mirror to a desired form; wherein
the control means controls the amount of deforming the reflecting surface by changing a duty ratio of a voltage applied across the upper electrode and the control electrode.
